(19) United States
(12) Patent Application Publication
(10) Pub. No.: US 2011/0248862 A1
(43) Pub. Date: Oct. 13, 2011

(54) USER INTERFACE FOR DEVICES WITH LIMITED INPUT/OUTPUT HARDWARE CAPABILITY

(75) Inventors: Ramakrishna Budampati, Maple Grove, MN (US); Michael Hamm, Maple Grove, MN (US); Henrik Holm, Kalamazoo, MI (US)

(73) Assignee: Honeywell International Inc., Morristown, NJ (US)

(21) Appl. No.: 12/756,606

(22) Filed: Apr. 8, 2010

(51) Int. Cl. G08B 21/00

(52) U.S. Cl. 340/679

(57) ABSTRACT

A method includes receiving, at a device operating in a first mode, a communication including a status indicator from a plurality of sensing devices, and storing the indicators in a memory. Operating in the first mode, a first input that includes a first actuation duration is received via a button, and the device is configured to operate in a second mode. The first actuation duration is longer than a first duration and shorter than a second duration, where an input duration exceeding the second duration configures the device to operate in a third mode. Operating in the second mode, an indication of the respective status indicator is provided on an output device for each of the status indicators. Transitions between the indications occur responsive to toggle inputs via the button. A second input is received via the button, and the device is configured to operate in the first mode.

### TECHNICAL FIELD

The disclosure relates to user interfaces, and more particularly to user interfaces for devices with limited input/output (I/O) hardware capability.

### BACKGROUND

With advancements in computing technology, many user interfaces for electronic devices have become very sophisticated. For example, user interfaces for some modern computing devices can receive and process user input entered via a standard keyboard, via a pointing device such as a mouse, or via a gaming controller (e.g., joystick, steering wheel, or gamepad). In some cases, the computing devices may be equipped with a microphone and voice recognition software, which may permit a user to speak commands that the computing device can interpret and execute. Similarly, some mobile phones or personal digital assistants (PDAs) include full keyboards or keypads that include multi-function buttons, or touch screens that are responsive to tactile input, as from a stylus or from an operator's finger. These and other devices can also include vibrant display screens, including high resolution display screens, that can present text, images, video, and multimedia content to provide a rich user interface experience for a user.

However, providing electronic devices that include sophisticated user interfaces can be costly. For example, hardware costs associated with the input or output devices mentioned above may be significant, and development or licensing costs associated with firmware or software to support the hardware may add to the expense. Also, for devices that may be operated in challenging physical environments (e.g., dirty, contaminated, hot, cold, noisy, jarring, and the like), a user interface that includes robust hardware to implement I/O functionality may be preferred to better withstand the harsh elements.

### SUMMARY

In general, the disclosure describes devices, systems, and methods that can be used to provide intuitive and user-friendly user interfaces for electronic devices, such as electronic devices with limited I/O hardware capability.

In a first general aspect, a method includes receiving, at a first electronic device, a communication from each of a plurality of electronic sensing devices. Each of the received communications includes a status indicator representative of a status of the respective electronic sensing device, and the first electronic device is configured to operate in a first mode of a plurality of operating modes while the communications are received. The method also includes storing, in a memory device accessible by the first electronic device, the status indicators included, respectively, in the received communications. The method further includes receiving, at the first electronic device while the first electronic device is operating in the first mode and via a button of the first electronic device, a first input comprising a first actuation duration that corresponds to a length of time that the button is actuated to provide the first input. The first actuation duration is longer than a debounce duration for the button, longer than a first duration, and shorter than a second duration, where the first duration is substantially longer than the debounce duration and the second duration is substantially longer than the first duration. Responsive to receiving the first input comprising the first actuation duration, the first electronic device is configured to operate in a second mode of the plurality of operating modes. An input received via the button while the first electronic device is operating in the first mode and including an actuation duration longer than the second duration causes the first electronic device to be configured to operate in a third mode of the plurality of operating modes, where the third mode is different than the first mode or the second mode. The method further includes providing, for each of the stored status indicators while the first electronic device is operating in the second mode, a visual indication of the respective status indicator on an output device of the first electronic device, where transitions between the provided visual indications of the status indicators occur in response to toggle inputs received via the button. The method further includes receiving, after providing the visual indications of the stored status indicators, a second input via the button, where the first electronic device is configured to operate in the first mode responsive to receiving the second input.

In a second general aspect, an electronic monitoring device includes a receiver, a memory device, a button, and an output device. The electronic monitoring device also includes a control module configured to receive, via the receiver, a communication from each of a plurality of electronic sensing devices, where each of the received communications includes a status indicator representative of a status of the respective electronic sensing device, and where the electronic monitoring device is configured to operate in a first mode of a plurality of operating modes while the communications are received. The control module is also configured to store, in the memory device, the status indicators included, respectively, in the received communications. The control module is further configured to receive, while the electronic monitoring device is operating in the first mode and via the button, a first input comprising a first actuation duration that corresponds to a length of time that the button is actuated to provide the first input. The first actuation duration is longer than a debounce duration for the button, longer than a first duration, and shorter than a second duration, where the first duration is substantially longer than the debounce duration and the second duration is substantially longer than the first duration. Responsive to receiving the first input comprising the first actuation duration, the control module configures the electronic monitoring device to operate in a second mode of the plurality of operating modes. An input received via the button while the electronic monitoring device is operating in the first mode and comprising an actuation duration longer than the second duration causes the control module to configure the electronic monitoring device to operate in a third mode of the plurality of operating modes, where the third mode is different than the first mode or the second mode. The control module is further configured to provide, for each of the stored status indicators while the electronic monitoring device is operating in the second mode, a visual indication of the respective status indicator on the output device, where transitions between the provided visual indications of the status indicators occur in response to toggle inputs received via the button. The control module is further configured to receive, after providing the visual indications of the stored status indicators, a second input via the button, and configure the electronic monitoring device to operate in the first mode, responsive to receiving the second input.

In a third general aspect, a computer-readable medium includes instructions for causing a programmable processor to receive, at a first electronic device, a communication from each of a plurality of electronic sensing devices, where each of the received communications includes a status indicator representative of a status of the respective electronic sensing device, and where the first electronic device is configured to operate in a first mode of a plurality of operating modes while the communications are received. The computer-readable medium also includes instructions for causing a programmable processor to store, in a memory device accessible by the first electronic device, the status indicators included, respectively, in the received communications. The computer-readable medium further includes instructions for causing a programmable processor to receive, at the first electronic device while the first electronic device is operating in the first mode and via a button of the first electronic device, a first input comprising a first actuation duration that corresponds to a length of time that the button is actuated to provide the first input. The first actuation duration is longer than a debounce duration for the button, longer than a first duration, and shorter than a second duration, where the first duration is substantially longer than the debounce duration and the second duration is substantially longer than the first duration. Responsive to receiving the first input comprising the first actuation duration, the first electronic device is configured to operate in a second mode of the plurality of operating modes. An input received via the button while the first electronic device is operating in the first mode and comprising an actuation duration longer than the second duration causes the first electronic device to be configured to operate in a third mode of the plurality of operating modes, where the third mode is different than the first mode or the second mode. The computer-readable medium further includes instructions for causing a programmable processor to provide, for each of the stored status indicators while the first electronic device is operating in the second mode, a visual indication of the respective status indicator on an output device of the first electronic device, where transitions between the provided visual indications of the status indicators occur in response to toggle inputs received via the button. The computer-readable medium further includes instructions for causing a programmable processor to receive, after providing the visual indications of the stored status indicators, a second input via the button, where the first electronic device is configured to operate in the first mode responsive to receiving the second input.

The details of one or more implementations are set forth in the accompanying drawings and the description below. Other features, objects, and advantages will be apparent from the description and drawings, and from the claims.

### BRIEF DESCRIPTION OF DRAWINGS

FIG. 1 is a block diagram of an exemplary system that includes an electronic monitoring device that is in communication via a network with other electronic devices.

FIG. 2 is a state change diagram of an exemplary sequence of operation modes that the monitoring device of FIG. 1 may implement.

FIG. 3 is a conceptual diagram of an exemplary crane that includes the electronic monitoring device and the electronic sensing devices of FIG. 1.

FIG. 4A is a conceptual diagram of an exemplary dump truck that includes the electronic monitoring device and the electronic sensing devices of FIG. 1.

FIG. 4B is a conceptual diagram of an exemplary dump truck that has tipped and is in an unsafe condition.

FIG. 5 is a block diagram of an exemplary electronic monitoring device suitable for use in the system of FIG. 1.

FIG. 6 is a flow chart of exemplary operations that can be performed by the electronic monitoring device of FIG. 5.

### DETAILED DESCRIPTION

This disclosure describes devices, systems, and methods that can be used to provide intuitive and user-friendly user interfaces for electronic devices. The user interface concepts discussed herein may be used with devices that include limited user interface hardware components. For example, the techniques discussed herein may be used with an electronic device that includes only a single, two-position button as an input component, and includes an output device comprising a limited number of two-state output components. Examples of two-state output components can include visible output media such as LEDs (light-emitting diodes) or audible output media such as buzzers, where the LEDs or buzzers may be either “on” (e.g., lighted or producing sound, respectively) or “off” (e.g., unlighted or silent, respectively) at a given time. In some examples, two-state output components may be driven to rapidly change state (e.g., a blinking LED or a beeping buzzer), and this can be used as a pseudo-third state for the component. Also, in some applications, an LED may be considered “off” when it is lighted, and “on” when it is not, and similarly for the buzzer.

The user interface concepts discussed herein, in some examples, may permit an abundance of information to be communicated between the electronic device and a user, despite the device's lack of sophisticated input/output (I/O) hardware. For example, a device that implements the techniques disclosed herein may permit a user to navigate a complex data structure using only a single input button, and may convey information pertaining to a large number of devices using only a few simple output components. In some implementations, this may facilitate lower-cost designs that nevertheless may effectively communicate information pertaining to the electronic device or to other electronic devices.

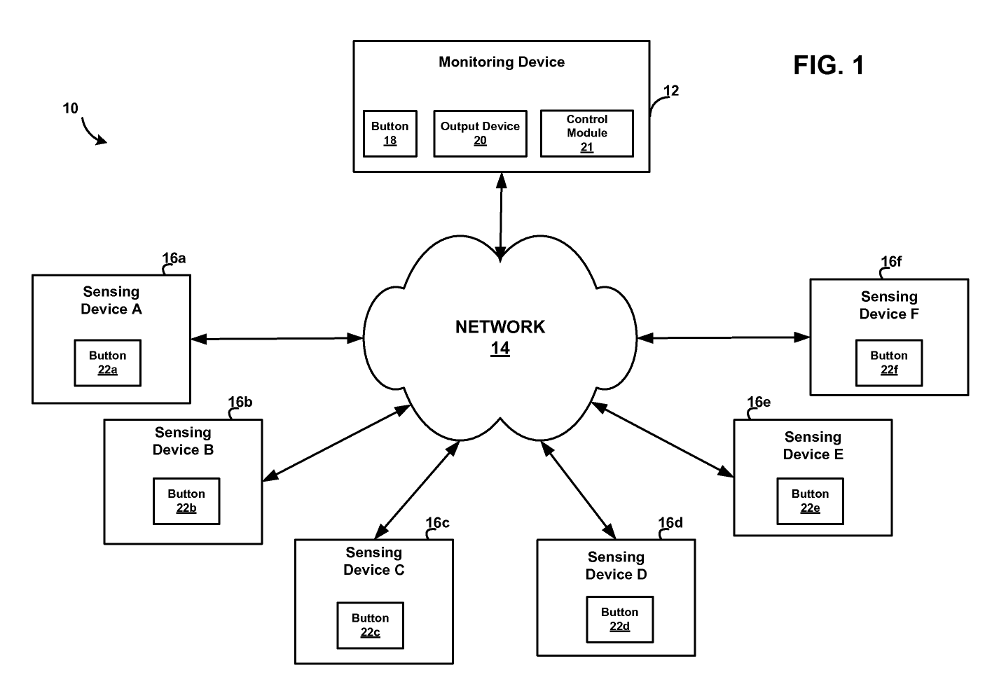

FIG. 1 is a block diagram of an exemplary system 10 that includes an electronic monitoring device 12 that is in communication via a network 14 with other electronic devices 16a-16f. In the depicted example, the other electronic devices 16a-16f are electronic sensing devices, and may communicate wirelessly via network 14 (or by a wired connection) with electronic monitoring device 12. In various implementations, electronic sensing devices 16a-16f may be wireless limit switches, and may be used to sense a presence or absence of a moving object. The discussion that follows assumes for consistency that the electronic sensing devices 16a-16f are limit switches, but it should be understood that the techniques disclosed herein may be applicable for a monitoring device and for any type of electronic sensing device, or for any type of electronic device that may be in communication with a monitoring device, such as electronic monitoring device 12. In some examples, monitoring device 12 may also be a sensing device. Network 14 may be a local area network, such as an IEEE 802.11 (WiFi) network (or one of its variants), an IEEE 802.15.4 network, a Bluetooth network, or any other appropriate wireless or wireline network. Sensing devices 16 may be battery-powered, and monitoring device 12 may be either battery-powered or line-powered, in various implementations.

In some examples, the sensing devices 16a-16f may actuate or operate to break a circuit or cut power to an output when a particular indication is sensed. In some implementations, the limit switches can be used on one or more machines to sense for actions that may cause an unsafe condition, and can provide a signal to prevent the unsafe condition from occurring upon detection of such an action. In some examples, the limit switches can provide or transmit a signal that alerts to the sensed indication or action, or that alerts that an unsafe condition may soon occur or has occurred. Examples of applications where a group of limit switches, such as switches 16a-16f, can be used include conveyor applications, or on loaders, forklifts, cranes (e.g., gantry, overhead, telescopic, tower, sidelift, jib, loader, and other crane types) lift bridges, jet bridges, ladder trucks, bulldozers, dump trucks, farm machinery, landscaping machinery, construction machinery, and the like.

The sensing devices 16a-16f may typically be dispersed at various locations within an environment, and may communicate with electronic monitoring device 12 via network 14. Monitoring device 12 may monitor each of the sensing devices 16a-16f, so that the sensing devices 16a-16f may comprise a collection of sensing devices being monitored by monitoring device 12. For example, in a manufacturing environment where repeated automated assembly of a particular good is performed by one or more assembly machines, each of limit switches 16a-16f may be positioned to sense for various types of motion or for a presence of an object at particular locations on the machine or machines.

At a construction site where two or more cranes may be operating, each crane may define its own environment. Each crane may include a monitoring device 12 and two or more sensing devices 16, where the two or more sensing devices 16 are in the monitoring device's collection of monitored devices. The devices 12, 16 on each crane may communicate with other devices, but may not communicate with similar devices on another crane, according to some examples, because of unique network identifiers used by devices in each system to prevent an unsafe situation that could result if information were communicated across systems. For example, at a construction work site where there are multiple cranes, several trucks, and a material transport system, where each of the cranes, trucks, and transport system includes a monitoring device 12 and sensing devices 16, each monitoring device 12 may monitor a collection of monitored sensing devices (e.g., those sensing devices 16 on that particular crane, truck or system) without overlap with the collections of other monitoring devices 12.

As described above, sensing devices 16a-16f may generally be limit switches in some examples. In some cases, a condition sensed for by a limit switch may be associated with an error or fault. In some cases, the condition that the limit switch senses for may be associated with a warning or caution. In some cases, the condition that the limit switch senses for may be associated with completion of an operation or of a sub-operation of a larger operation.

Monitoring device 12 and sensing devices 16a-16f may not include sophisticated hardware for input or output functionality, according to some implementations. For example, the devices 12, 16a-16f may not include display screens, keyboards, or multi-key keypads. Rather, in the depicted example, monitoring device 12 includes a button 18 that can be actuated to provide an input signal to monitoring device 12, and an output device 20 that the monitoring device 12 can use to convey information to a user. In various implementations, button 18 may be a two-position, tactile button. In some implementations, button 18 may be a simple push button, a dip switch, a joy stick, or a roller ball. In some examples, button 18 may be the only input mechanism supported by monitoring device 12 for receiving input from a user, such as during a configuration stage or an operating stage. That is, monitoring device 12 may include only a single input button 18, and may not include other buttons or input hardware typically associated with rich user interfaces.

Output device 20 may include a limited number (e.g., two, three, four, five, or the like) of two-position or two-state output components. Examples of two-state output components can include light emitting diodes (LEDs) or buzzers. In one example, output device 20 includes three LEDs and one buzzer. It will be understood that the output components that comprise output device 20 are not limited to two-state LEDs or buzzers. For example, multi-color LEDs, LED arrays, or buzzers or speakers that may be driven to produce two or more different sounds, or other limited functionality output devices, may also be used.

Monitoring device 12 includes a control module 21 that is operable to execute the user interface techniques discussed herein. Control module 21 may comprise hardware, and in some implementations may additionally comprise software or firmware components in some combination, according to various implementations. Control module 21 may be operable to perform user interface tasks or make decisions based (at least in part) on received inputs or operating modes, for example.

Each of sensing devices 16a-16f includes a button (22a-22f, respectively) that can be actuated to provide an input signal to the respective sensing device 16a-16f. Buttons 22a-22f may be two-position, tactile buttons, similar to button 18 on monitoring device 12. In some examples, each of sensing devices 16a-16f may include one button 22a-22f, respectively, as the only input mechanism supported by the respective sensing device 16 for receiving input from a user, such as during a configuration stage (or another stage, e.g., an operating stage). That is, each of sensing devices 16a-16f may include only a single input button (22a-22f, respectively), and may not include other hardware typically associated with rich user interfaces. In the depicted example, the sensing devices 16 do not include hardware for providing output information, but in other examples the sensing devices 16 may include one or more LEDs, buzzers, or the like.

Monitoring device 12 may operate in one of two or more operating modes, and may operate differently depending on the operating mode in which the device 12 is currently operating. For example, the device 12 may perform different actions in a first operating mode than in a second operating mode, and may only perform certain actions in certain operating modes. In various implementations, monitoring device 12 may react differently to input received via button 18 depending on the operating mode in which the device 12 is currently operating. That is, monitoring device 12 may react differently to a given input when operating in one operating mode than it would if operating in another operating mode. For example, a first input received via button 18 by monitoring device 12 while the device 12 is operating in a first mode may cause the device 12 to perform a first action, where receipt of the same input via the button 18 while the device 12 is operating in a second mode may cause the device 12 to perform a second, different, action. As another example, an output displayed on output device 20 may have different meanings based on the prevailing operating mode of device 12.

During operation, monitoring device 12 may transition between operating modes. In some examples, monitoring device 12 may transition between operating modes in response to an input received via button 18. Alternatively, monitoring device 12 may transition between operating modes in response to an occurrence of an action, or after a predetermined time duration following an occurrence of an action. As such, monitoring device 12 may transition or change operating modes in response to user inputs (e.g., via button 18) or in response to an action that is not a user input.

Each input received by monitoring device 12 via button 18 may be associated with an actuation duration that corresponds to a length of time that the button 18 is actuated or pressed (e.g., by a user) to provide the input. For example, an input may be associated with an actuation time of one second, which may indicate that button 18 was actuated for about one second to provide the input. In other examples, the actuation duration may be about two seconds, four seconds, five seconds, eight seconds, ten seconds, twelve seconds, sixteen seconds, or the like. Monitoring device 12 may include a timer (not shown) that can be used to determine an actuation duration for an input received via button 18.

As discussed above, monitoring device 12 may receive input via button 18, where each input may be associated with an actuation duration. In some examples, monitoring device 12 may use a combination of the current operating mode of the device 12 and an actuation duration of a received input to guide a future action of the device 12. An alternative actuation duration that is shorter or longer may cause one or more different future actions.

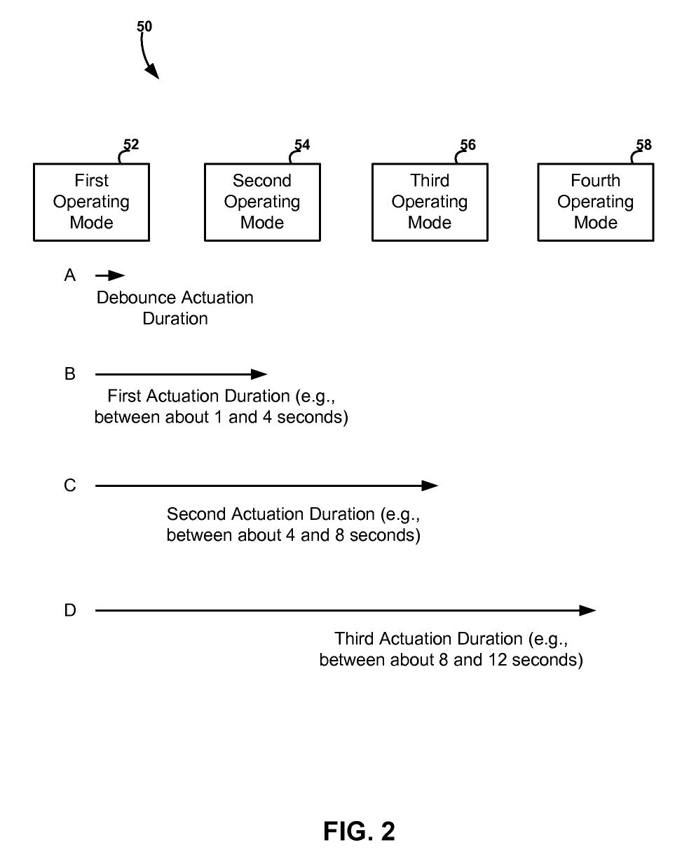

FIG. 2 is a state change diagram of an exemplary sequence 50 of operation modes that the monitoring device 12 of FIG. 1 may implement. In this example, an electronic device (e.g., monitoring device 12) may initially be configured to operate in a first operating mode 52. The device may transition to one of two or more additional operating modes based on a receipt of an input (e.g., via button 18) associated with an actuation duration, where the actuation duration may be used to determine (at least in part) whether an operating mode transition is appropriate.

A first actuation duration (B) may be in a range of about one second to about four seconds. While operating in first operating mode 52, monitoring device 12 may receive an input via button 18 and associated with the first actuation duration (B). Control module 21 of monitoring device 12 may cause the current operating mode for the device to transition from the first operating mode 52 to a second operating mode 54 based on the input and the first actuation duration (B). In other words, if the monitoring device 12 is operating in the first operating mode 52 and receives a button input where the button was actuated for a time period of between about one second and about four seconds (i.e., the first actuation duration (B)), the control module 21 of the monitoring device 12 may configure the monitoring device 12 to operate in the second operating mode 54. While actuation duration (B) is described above in terms of a range, it may alternatively refer to a lower limit, such as one second in this example.

A second actuation duration (C) may be in a range of about four seconds to about eight seconds. While operating in first operating mode 52, monitoring device 12 may receive an input via button 18 and associated with the second actuation duration (C). Control module 21 of monitoring device 12 may cause the current operating mode for the device to transition from the first operating mode 52 to a third operating mode 56 based on the input and the second actuation duration (C). In other words, if the monitoring device 12 is operating in the first operating mode 52 and receives a button input where the button was actuated for a time period of between about four seconds and about eight seconds, the control module 21 of the monitoring device 12 may configure the monitoring device 12 to operate in the third operating mode 56. While actuation duration (C) is described above in terms of a range, it may alternatively refer to a lower limit, such as four seconds in this example.

A third actuation duration (D) may be in a range of about eight seconds to about twelve seconds. While operating in first operating mode 52, monitoring device 12 may receive an input via button 18 and associated with the third actuation duration (D). Control module 21 of monitoring device 12 may cause the current operating mode for the device to transition from the first operating mode 52 to a fourth operating mode 58 based on the input and the third actuation duration (D). In other words, if the monitoring device 12 is operating in the first operating mode 52 and receives a button input where the button was actuated for a time period of between about eight seconds and about twelve seconds, the control module 21 of the monitoring device 12 may configure the monitoring device 12 to operate in the fourth operating mode 58. While actuation duration (D) is described above in terms of a range, it may alternatively refer to a lower limit, such as eight seconds in this example.

In some cases, input button 18 may be actuated accidentally, such as by brushing against the button 18 while not intending to actuate it. Also, release of the button may cause a short bounce in an output signal of the button that may be mistaken for an intended actuation of the button in some cases. The control module may use a debounce actuation duration (A) to determine whether a legitimate input was received via the button 18. Inputs associated with actuation durations that are shorter than the debounce actuation duration (A) may be discarded or ignored, as such inputs may correspond to accidental or unintentional inputs. The debounce actuation duration may be any suitable length of time, such as, for example, about 100 milliseconds. Other examples of debounce actuation durations may be 200 milliseconds, 300 milliseconds, 400 milliseconds, 500 milliseconds, 1 second, and the like. When an input is received via button 18 and associated with an actuation duration that is less than the debounce actuation duration (A) while monitoring device 12 is operating in the first operating mode 52, the control module 21 may not cause device 12 to transition between operating modes, and may continue to configure the device 12 to operate in the first operating mode 52.

The exemplary actuation durations discussed above are for illustrative purposes, and many variations are possible. For example, the first actuation duration (B) may alternatively be in a range of about 500 milliseconds to about three seconds, or in a range of about one second to about three seconds. The second actuation duration (C) may alternatively be in a range of about three seconds to about seven seconds, and the third actuation duration (D) may alternatively be in a range of about seven seconds to about ten seconds. In general, the ranges for the debounce actuation duration, and the first, second and third actuation durations may not overlap, except perhaps at endpoints of the ranges in some cases. In some cases, the ranges for the various durations may be contiguous, and in other cases the ranges for the various durations may not be contiguous.

Examples of operating modes that monitoring device 12 may operate in can include, without limitation, a “normal” mode, a “troubleshooting” mode, a “pairing” mode, or a “purge” mode. In some examples, normal mode may correspond to the first operating mode 52, troubleshooting mode may correspond to the second operating mode 54, pairing mode may correspond to the third operating mode 56, and purge mode may correspond to the fourth operating mode 58.

Pairing mode may be used to communicatively associate monitoring device 12 with one or more sensing devices 16. Such an association may be made during a configuration stage, for example, and may be used to establish or define the monitoring device's collection of monitored devices.

While operating in pairing mode, monitoring device 12 may listen for a request from a sensing device 16, where the request is a communication received via network 14. A sensing device (e.g., device 16a) may transmit such a join request communication for receipt by monitoring device 12 in an effort to be added to a collection of sensing devices that are monitored by monitoring device 12. When monitoring device 12 receives a join request communication while in pairing mode, it may add the requesting sensing device to a collection of devices to be monitored, and may transmit, via network 14, an acceptance communication to the requesting sensing device confirming its inclusion in the monitoring device's collection. When operating in pairing mode, monitoring device 12 may automatically transition to the normal operating mode after a predetermined period of time, or following a predetermined period of inactivity (e.g., about 30 seconds). For example, if no join requests are received within a predetermined period of time, monitoring device 12 may transition to normal mode.

In some examples, the monitoring device 12 and the sensing device 16 are both operating in a pairing operating mode when the request to join and acceptance communication are sent and received. While the sensing device 16 may include different operating modes in general than monitoring device 12, sensing device 16 may similarly be caused to change operating modes by providing input via button 22.

In some examples, an actuation duration associated with the input via button 22 may be used to determine an appropriate operating mode for the sensing device 16. For example, when sensing device 16 is operating in a normal mode, an input via button 22 associated with an actuation duration of one second or longer may cause the sensing device 16 to transition from the normal mode to a pairing operating mode.

In some examples, one or more of the sensing devices 16 may not include button 22. For example, sensing device 16 may alternatively include a communication port such as a near field communication port (e.g., an infrared (IR) port). A user may use a handheld device that includes an IR port to send a signal to the port on the sensing device 16, and this signal may be used to configure the sensing device 16 to operate in pairing mode, according to some examples. In a similar manner, sensing device 16 may include a magnetic communication port, near which a user may position a corresponding external magnet in an appropriate orientation to cause the sensing device 16 to be configured to operate in pairing mode. As yet another example, in some implementations the sensing device 16 may be configured to permit a user to manually trigger the sensing device 16 according to a predetermined schedule (e.g., trigger device five times within 30 seconds) to cause the sensing device 16 to enter pairing mode. The predetermined schedule can be chosen such that it would be extremely unlikely to spontaneously occur.

In some examples, the sensing devices 16 may include two operating modes: a normal mode and a pairing mode. When a sensing device 16 is configured to operate in its pairing mode, it may send the join request described above and listen for an acceptance communication from the monitoring device 12. The sensing device 16 may listen for a predetermined period of time, and if no acceptance communication has been received from monitoring device 12 within the predetermined period of time, the sensing device 16 may resend the join request.

In general, all communications between monitoring device 12 and a sensing device 16 may include a security key that can be used to securely encode or decode the message. Sensing device 16 may be factory-configured with a default key, and may use the default key in the initial join request communication. Monitoring device 12 may also include the default key, and may use it to decode the join request communication. Monitoring device 12 may further include a second security key for ongoing communications with the sensing devices in its monitored collection, and may provide the second security key to the requesting sensing device 16 in the acceptance communication. Thereafter, communications between the requesting sensing device and the monitoring device may use the second security key.

Monitoring device 12 may additionally provide an identification number to the requesting sensing device in the acceptance communication. The identification number may uniquely identify the requesting sensing device among the collection of sensing devices being monitored by monitoring device 12. Thereafter, communications between monitoring device 12 and the requesting device 16 may include the identification number for identification purposes.

Normal operating mode may be a default operating mode for monitoring device 12, and may correspond to an operating mode that the monitoring device 12 automatically reverts to from one or more other operating modes. As will be described more fully below, while operating in normal operating mode, monitoring device 12 may receive periodic status update communications from two or more sensing devices 16. Additionally, monitoring device 12 may receive a communication from a sensing device 16 when the device 16 actuates (e.g., when a limit switch actuates) or changes state. Monitoring device 12 may provide a visual indication (perhaps combined with an audible indication) of a composite status on output device 20, where the composite status is a collective representation of the statuses of the sensing devices 16 in the monitoring device's collection of monitored devices.

For example, in an implementation where output device 20 comprises three LEDs and one buzzer, a visual indication of one LED lit may indicate that all sensing devices 16 in the collection are operating normally. A visual and audible indication of one LED lit and the buzzer producing sound may indicate that one or more sensing devices 16 in the collection are actuated. A visual indication of two LEDs lit (or alternatively of one LED lit and another LED blinking) may indicate that one or more sensing devices 16 in the collection have a low battery condition. A visual indication of three LEDs lit (or alternatively of two LEDs lit) may indicate a bad communication link (i.e., unable to communicate with) one or more sensing devices 16 in the collection.

In various implementations, the sensing devices 16a-16f may provide status updates to monitoring device 12 at regular or substantially regular intervals. For example, monitoring device 12 may periodically receive a communication from each of the sensing devices 16a-16f via network 14, where the communication includes a status indicator representative of a status of the respective sensing device. The status indicators can include various types of information. Examples of information that can be conveyed from a sensing device 16 to the monitoring device 12 during such a status update can include whether the switch is currently actuated, and an indication of battery status at the switch (e.g., “okay” or “low”). The communication may also include an identifier, such as an identification number that identifies the particular switch (e.g., switch 16a) to the monitoring device 12. Other examples of information that may be conveyed from a sensing device 16 to monitoring device 12 during a status update communication can include a count of a number of limit switch actuations over a time interval, a position indication, a status code or error code descriptive of an operating status or fault condition at the switch, timing information, and the like. In various examples, the communication may also include an indication of communication signal strength or of communication link quality (e.g., from the monitoring device 12 to the sensing device 16). In examples where a sensing device 16 senses for a condition that is a safety concern, the communication may include a fail-safe indication that the monitoring device 12 can track so that if communications with the sensing device 16 cease, the monitoring device 12 may provide an output indication that there may be a safety concern.

Monitoring device 12 may receive (e.g., via a receiver, not shown in FIG. 1) the status communications from the various sensing devices 16 via network 14, and may store the received status indicators in a memory device (not shown in FIG. 1). The memory device may be accessible by the monitoring device 12, and may be internal to the monitoring device 12 or external of it. The memory device may be a volatile or nonvolatile memory device, and each status indicator may be stored in association with an identifier that identifies the sensing device 16 responsible for sending the communication. In this manner, monitoring device 12 may maintain a repository of information regarding each of the sensing devices 16 within its monitored environment so that at any point it may provide such information or a portion of such information via output device 20, for example. In various examples, monitoring device 12 may acknowledge receipt of the status communications by transmitting (e.g., via a transmitter, not shown in FIG. 1) a communication to the respective sensing device 16 that informs the sensing device 16 that its status communication was received.

Troubleshooting mode may be used to provide information on individual sensing devices 16. For example, monitoring device 12 may provide, via output device 20, a visual indication (perhaps combined with an audible indication) of a status of a particular sensing device (e.g., device 16a). That is, at a given time while operating in troubleshooting mode, output device 20 may reflect a status of one sensing device 16. This may be in contrast, for example, to the composite status visual indication (perhaps combined with an audible indication) described above with respect to the normal operating mode. While monitoring device 12 is operating in troubleshooting mode, a user may cycle through each of the sensing devices by toggling (pressing) the button 18, and the monitoring device 12 may update output device 20 each time the button 18 is pressed to reflect a status of a different sensing device 16 within the monitoring device's collection of monitored devices.

The monitoring device 12 may receive an input via button 18 while operating in the troubleshooting mode, and the control module may update output device 20 to reflect a status of a different sensing device 16 (e.g., device 16b). Monitoring device 12 may access the corresponding status indicator from the memory device, the status indicator having been earlier stored in the memory device. In this manner, a user may view a visual representation on output device 20 of the statuses of each of the sensing devices 16, in turn, by pressing button 18 in troubleshooting mode to cycle through status indications for each of the sensing devices 16.

For each button press input received, the control module 21 may provide a visual indication (perhaps combined with an audible indication) of a status for a different sensing device 16 until statuses have been provided for each of the sensing devices 16 within the monitoring device's collection of monitored devices (e.g., for each of devices 16a-16f, see FIG. 1). Upon receipt of a button press input, the control module 21 may cause the buzzer to rapidly beep “X” number of times, where “X” corresponds to the identification number of the sensing device whose status is being displayed. In this manner, the user may be apprised of the sensing device 16 whose status is currently being displayed on output device 20. A next button press, following the button press that caused a visual indication (perhaps combined with an audible indication) of a last sensing device 16 to be displayed, may cause the control module 21 to configure the monitoring device 12 to operate in the normal operating mode.

Various individual status indications can be provided on output device 20. As described above, control module 21 may access the individual status indicators that were stored in the memory device and provide a visual (or perhaps visual and audible) status indication on output device 20. In implementations where output device 20 includes three LEDs and a buzzer, control module 21 may light one LED to indicate that the particular sensing device is operating normally. If the sensing device has actuated, control module 21 may light one LED and cause the buzzer to sound.

If the sensing device has a low battery condition, the control module 21 may light one LED and cause a second LED to blink. It the sensing device has actuated and has a low battery condition, the control module 21 may light one LED and cause a second LED to blink, and may cause the buzzer to sound. If the sensing device has a bad communication link (i.e., monitoring device 12 has not received a status update from the sensing device for a predetermined period of time), control module 21 may cause one LED to blink. If a sensing device that was previously among the collection of monitored devices has been purged and is no longer among the collection of monitored devices, the control module 21 may cause one LED to blink and may cause the buzzer to beep a number of times equal to an identification number of the purged device.

Purge mode may be used to remove one or more sensing devices 16 from the monitoring device's collection of monitored sensing devices. Removing such a sensing device 16 may be appropriate if the sensing device is no longer needed in the application, for example, if the sensing device has malfunctioned, or if a battery at the sensing devices requires replacement or recharging.

As described above, sensing devices 16 within the monitoring device's collection of monitored devices send periodic status updates to the monitoring device 12. If monitoring device 12 fails to receive a status update from a particular sensing device for a predetermined period of time (e.g., about one minute, though durations from a few seconds to a few minutes may be used), the monitoring device 12 may conclude that the particular sensing device is not functioning. Monitoring device 12 may store an indication of this conclusion in the memory device, and when monitoring device enters purge mode, it may purge all entries associated with the particular sensing device and remove the sensing device from its collection of monitored devices. Control module 21 may cause one of the LEDs to flash “Y” number of times, where “Y” corresponds to the identification number of the particular sensing device. In this manner, the user may be apprised of the sensing device 16 that has been purged from the collection of monitored devices. Next, monitoring device may automatically transition to normal operating mode.

In some implementations, a user may cause monitoring device 12 to enter purge mode each time a sensing device 16 is to be removed from the collection of monitored devices, as described above. Alternatively, monitoring device 12 may purge all sensing devices determined to be inoperable at once. In this case, control module 21 may cause an LED of output device 20 to blink Y number of times as described above for each device being purged, and may insert a pause between each successive display of purged identification number.

As yet another option, upon entering purge mode, control module 21 may cause one of the LEDs to flash “Z” times, where “Z” corresponds to the identification number of a candidate sensing device for purging. Monitoring device 12 may then wait for a predetermined period of time (e.g., about 15 seconds), and if an input button press (via button 18) is received within the predetermined period of time, the corresponding sensing device may be purged. If an input button press is not received within the predetermined period of time, the corresponding sensing device may not be purged.

Additional modes are possible but are not shown in FIG. 2 for brevity. For example, an abort mode may correspond to a fifth operating mode, and a factory reset mode may correspond to a sixth operating mode. The abort mode may be associated with a fourth actuation duration, which may be in a range of about twelve seconds to about sixteen seconds (or associated with a lower limit of twelve seconds, e.g.), and the factory reset mode may be associated with an actuation duration lower limit of sixteen seconds, for example. While operating in first operating mode 52, monitoring device 12 may receive an input via button 18, where an associated actuation duration of 12-16 seconds causes the device 12 to enter the abort mode, and an actuation duration of longer than sixteen seconds causes the device to enter a factory reset mode. Abort mode may simply cause the device 12 to transition immediately to normal mode again. Factory reset mode may cause the device 12 to assume a factory configuration.

Monitoring device 12 may enter a power-on operating mode when power is applied, and may perform various configuration activities before entering normal mode. Monitoring device 12 may perform a scan to determine whether there are any other similar networks in the vicinity. Such a scan may be an active scan or a passive scan. With an active scan, monitoring device 12 may send one or more wireless broadcast messages requesting a reply to the message(s), and listen to see whether another device replies. With a passive scan, monitoring device 12 may listen for any on-going communication traffic. Scans can be performed at various channels, and a free channel can be selected and used for communicating with sensing devices 16. Monitoring device can select a network identifier (e.g., a 16-bit network identifier) and a network key (e.g., a 128-bit security key) using one or more pseudo-random number generators for use in communications with sensing devices 16. After performing these configuration activities, monitoring device may transition from the power-on operating mode to normal operating mode.

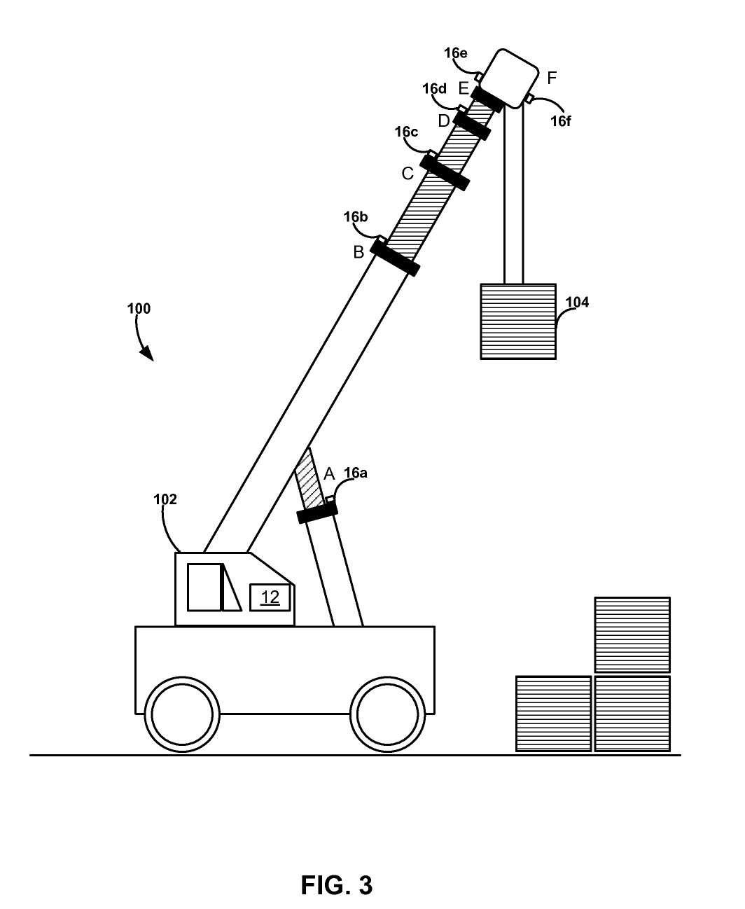

FIG. 3 is a conceptual diagram of an exemplary crane 100 that includes the electronic monitoring device 12 and the electronic sensing devices 16a-16f of FIG. 1. Crane 100 is a telescopic crane, but the techniques, devices, and systems described herein may be applicable to other types of cranes, mobile or fixed, as well. For example, a gantry crane, overhead crane, tower crane, sidelift crane, jib crane, loader crane, floating crane, aerial crane, trolley crane, latticework crane, hammerhead crane, or a truck-mounted crane may also use one or more monitoring devices 12 and sensing devices 16, and the techniques described herein.

Monitoring device 12 is shown within a cabin 102 of the crane, where it may be accessed by an operator of the crane, for example. In particular, the operator may reference the output device 20 (see FIG. 1) of the monitoring device 12 for information pertaining to the sensing devices 16. Also, the operator may use the button 18 (see FIG. 1) of monitoring device 12 to provide input to the monitoring device 12. Input provided via the button 18 may be used to configure the monitoring device 12, according to some examples.

Sensing devices 16a-16f are wireless limit switches in this example, and communicate wirelessly with monitoring device 12. The limit switches may function as described above to sense for acceptable limits of travel of portions of the crane 100. Sensing devices 16a-16f may be respectively located at measurement points A-F on the crane 100. Other examples of areas that can be monitored but are not shown in FIG. 3 include sensing whether outriggers are in a correct position, or sensing whether a boom of the crane has rotated to (or beyond) a maximum permitted angle. In some cases, a sensing device can sense whether the crane itself has rotated to or beyond a maximum permitted angle.

The crane operator may be tasked with loading or stacking pallets 104 of materials. While performing this task, the operator may reference monitoring device 12. For example, when monitoring device 12 is operating in normal mode, the operator may reference the device 12 to view a composite status indication on output device 20 (see FIG. 1), where the composite status indication is a collective representation of status indicators for each of sensing devices 16a-16f. If the operator may desire information on a particular sensing device 16, the operator may press button 18 on monitoring device 12 for a certain period of time (e.g., at least about one second but not longer than about four seconds) to cause the device 12 to enter troubleshooting mode, as described above. The operator may then review the status of each of sensing devices 16a-16f in turn by toggling button 18, where each time the button 18 is toggled, device 12 may update output device 20 to provide a visual or audible (or both) indication of the status of a different sensing device within the collection of monitored sensing devices (devices 16a-16f in this example).

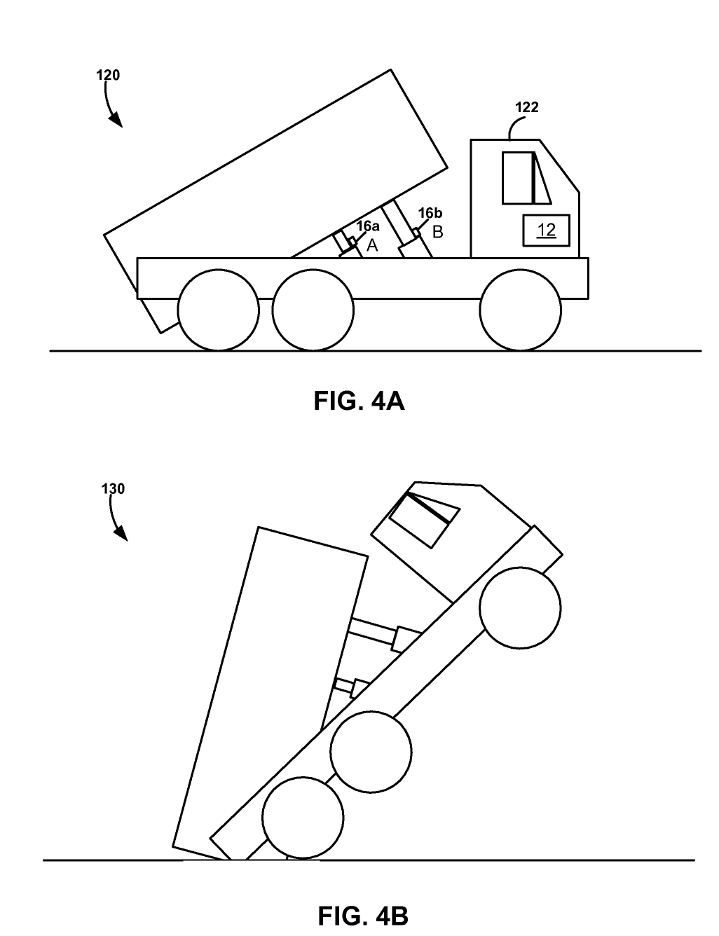

FIG. 4A is a conceptual diagram of an exemplary dump truck 120 that includes the electronic monitoring device 12 and the electronic sensing devices 16a-16b of FIG. 1. Monitoring device 12 is shown within a cabin 122 of the truck, where it may be accessed by an operator of the truck, for example. In particular, the operator may reference the output device 20 (see FIG. 1) of the monitoring device 12 for information pertaining to the sensing devices 16. Also, the operator may use the button 18 (see FIG. 1) of monitoring device 12 to provide input to the monitoring device 12. Input provided via the button 18 may be used to configure the monitoring device 12, according to some examples.

Sensing devices 16a-16b are wireless limit switches in this example, and communicate wirelessly with monitoring device 12. The limit switches function as described above to sense for acceptable limits of travel of portions of the truck 120. Sensing devices 16a-16b are respectively located at measurement points A and B on the truck. FIG. 4B is a conceptual diagram of an exemplary dump truck 130 that has tipped and is in an unsafe condition. Monitoring device 12 and sensing devices 16 are designed to prevent unsafe conditions, such as the tipped condition shown in FIG. 4B, from occurring.

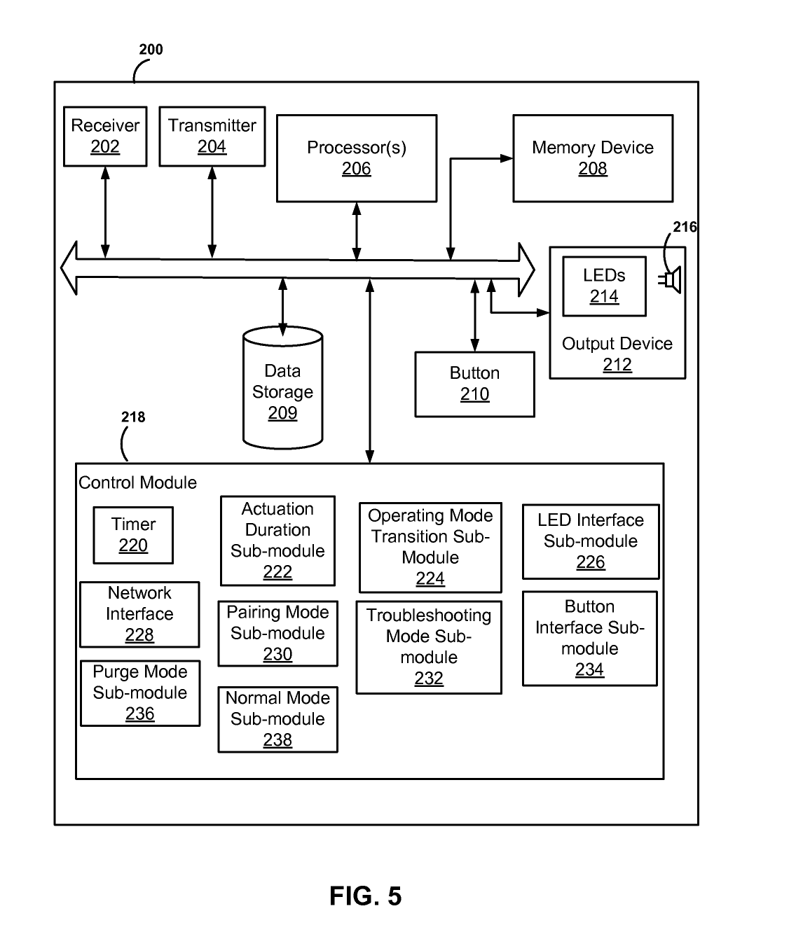

FIG. 5 is a block diagram of an exemplary electronic monitoring device 200 suitable for use in the system of FIG. 1. Electronic monitoring device 200 may correspond to electronic monitoring device 12 (see, e.g., FIG. 1), for example. Monitoring device 200 includes a receiver 202 and a transmitter 204 that can be used to receive and transmit messages to communicate with other electronic devices (e.g., sensing devices 16) over a network, such as network 14 (see FIG. 1). For example, receiver 202 can receive status communications or join requests from sensing devices, as described above, and transmitter can transmit acceptance communications to join requests or acknowledgement communications responsive to receipt of status communications.

Monitoring device 200 also includes one or more processors 206. The discussion that follows will assume one processor, but some monitoring devices may include two or more processors. The processor 206 may implement or execute instructions to perform methods, processes, or techniques discussed herein. The processor 206 may be a microprocessor, a microcontroller, a digital signal processor (DSP), or one or more instantiated cores of an application specific integrated circuit (ASIC) or a programmable logic device, such as a field programmable gate array (FPGA), to list just a few examples.

Monitoring device 200 also includes memory device 208 and data storage device 209. In some examples, memory device 208 may be a volatile memory device, and in other examples may be a non-volatile memory device. Data storage device 209 may provide non-volatile storage for firmware, software, or for data or parameters that can be used to aid in providing the user interfaces discussed herein. In some examples, software, firmware, or code comprising instructions or data may be loaded from data storage device 209 to memory device 208, and may be executed or operated on by processor 206.

Monitoring device includes a button 210, which may correspond to button 18 in FIG. 1, and an output device 212, which may correspond to output device 20 in FIG. 1. Button 210 may be a two-position, tactile button. Bias and filtering circuitry may also be included and associated with button 210, but are not shown for simplicity. Output device 212 includes two or more LEDs 214 and a buzzer 216, in this example. LEDs 214 and buzzer 216 represent two-state output devices. In other examples a different number of two-state output devices may be used. Bias and filtering circuitry may also be included and associated with button 210 or output device 212, but are not shown for simplicity. Monitoring device 200 does not include a display, and does not include a keyboard or a multi-function keypad that includes multiple keys. In one example, output device 212 includes three LEDs 214 and one buzzer 216.

Control module 218 may correspond to control module 21 shown in FIG. 1 and described above. Control module 218 includes various sub-modules, including a timer 220, an actuation duration sub-module 222, an operating mode transition sub-module 224, an LED interface sub-module 226, a network interface 228, a pairing mode sub-module 230, a troubleshooting mode sub-module 232, a button interface sub-module 234, a purge mode sub-module 236, and a normal mode sub-module 238. Additional sub-modules, including sub-modules to provide operating mode functionality described above, may also be included, but are not shown for simplicity.

Timer 220 may consist of one or more timers or counters, and may be used to time actuation durations for button 210. Timer 220 may also be used to time various periods that can be used to implement the techniques discussed herein, such as timeout periods, waiting periods, response periods, and the like. Network interface 228 may be used with receiver 202 and transmitter 204 to facilitate communication with other electronic devices via a network, such as network 14 (see FIG. 1). For example, network interface 228 may be used to facilitate any of the communications between devices discussed herein. LED interface sub-module 226 may be used to drive LEDs 214. Button interface sub-module 234 may be used to process input received via button 210. The various mode sub-modules 230, 232, 236, 238, may work together with LED interface sub-module 226 and button-interface sub-module 234 to provide the user interface features discussed herein.

Pairing mode sub-module 230 may be operable to implement the techniques described above with reference to the pairing operating mode, including managing the addition of sensing devices 16 to a collection of monitored devices for monitoring device 12. For each sensing device added to the collection, pairing mode sub-module 230 may update a memory location with information pertaining to the added sensing device. Normal mode sub-module 238 may be operable to implement the techniques described above with reference to the normal operating mode. For example, normal mode sub-module 238 may access stored status indicators from memory for the sensing devices in the collection of monitored devices, and may determine a composite status indicator representative of the statuses of each of the sensing devices in the collection. Sub-module 238 may then cause the composite status indicator to be presented on output device 212. Sub-module 238 may coordinate receipt of status or actuation messages from the sensing devices, and note whether any devices are failing to report.

Troubleshooting mode sub-module 232 may be operable to implement the techniques described above with reference to the troubleshooting operating mode. For example, sub-module 232 may access individually stored status indicators, and may cause a representative status to be presented on output device 212 for a particular sensing device. Purge mode sub-module 236 may be operable to implement the techniques described above with reference to the purge operating mode.

Actuation duration sub-module 222 may be operable to determine actuation durations associated with received inputs via button 210. The various mode sub-modules 230, 232, 236, 238, may use these actuation duration determinations to guide navigation of the user interface, according to some examples.

Operating mode transition sub-module 224 manages transitions between operating modes for monitoring device 200. In some examples, sub-module 224 uses actuation duration determinations provided by sub-module 222 to determine whether to configure device 200 with a new or different operating mode. For example, if the device 200 is operating in a first operating mode (e.g., normal operating mode) and an input is received via button 210, actuation duration sub-module 222 may determine an actuation duration associated with the input, which may correspond to a length of time that the button 210 was pressed to provide the input. Operating mode transition sub-module 224 may compare the determined actuation duration to a debounce actuation duration (e.g., about 100 ms), a first duration or duration limit (e.g., about 1 second), and a second duration or limit (e.g., about 4 seconds). If the input actuation duration is less than the debounce actuation duration, the input may be ignored and no operating mode change may be made.

If the input actuation duration is more than the debounce actuation duration and more than the first duration but less than the second duration, an operating mode change to a second operating mode (e.g., troubleshooting mode) may be made. If the input actuation duration exceeds the second duration, an operating mode change to a third operating mode (e.g., pairing mode) may be made. In the above example, the first duration may be substantially larger than the debounce actuation duration (e.g., 1 second versus 100 ms), and the second actuation duration may be substantially larger than the first actuation duration (e.g., 4 seconds versus 1 second).

Operating mode change sub-module 224 also manages other types of operating mode transitions, including those that occur automatically in response to an action (e.g., transitions to normal mode after a final toggle in troubleshooting mode, as described above, or after purging a sensing device in purge mode), or following a predetermined time period (e.g., transitions to normal mode after a period of inactivity in pairing mode).

In various examples, any of the modules or sub-modules may be implemented in or be operable to be executed by the processor 206. In some examples, one or more of the modules or sub-modules may comprise hardware, software, firmware, or a combination of the foregoing. In some examples, one or more of the modules or sub-modules, or a portion thereof, may be implemented within processor 206. In some examples, the modules and/or sub-modules may reside in data storage 209 or in memory device 208. In various examples, the modules or sub-modules may be combined or separated in various manners, and additional or fewer modules or sub-modules may be used. Although the modules are shown coupled to a bus in FIG. 5, in various examples the modules could be implemented in various different ways.

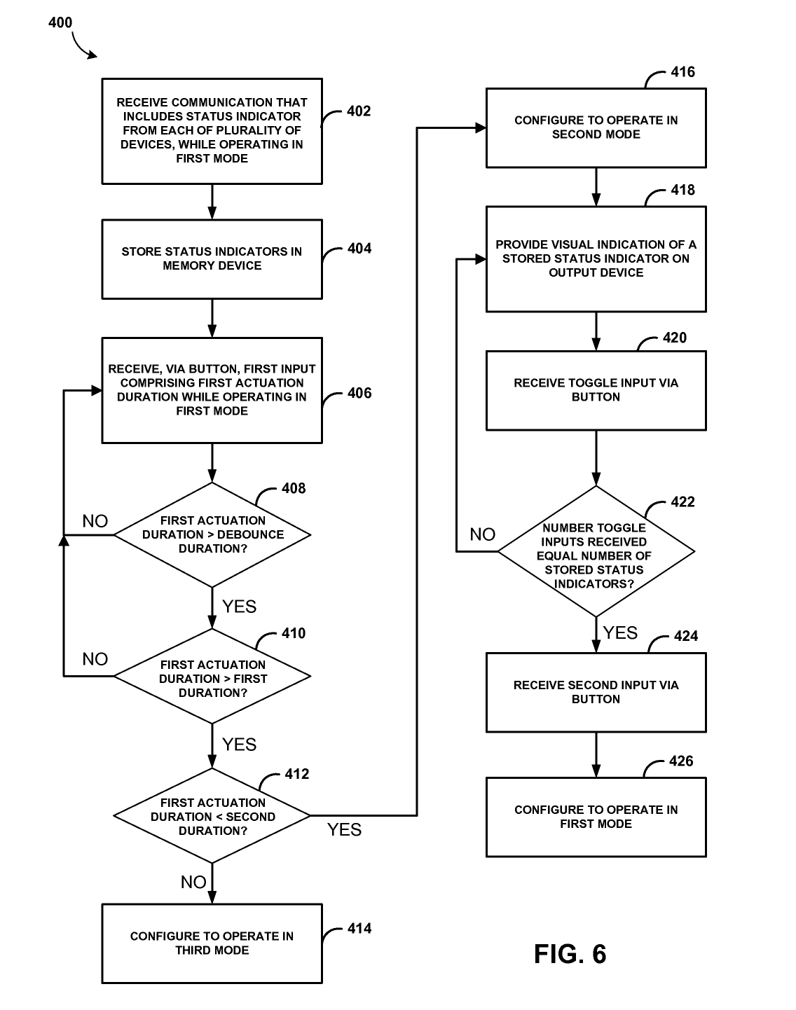

FIG. 6 is a flow chart of an exemplary method 400 that can be performed by an electronic monitoring device to provide a user interface. For example, the method 400 can be performed by device 12 or by device 200. A communication that includes a status indicator is received at a first electronic device from each of a plurality of devices while operating in a first mode (402). The first mode may be a normal operating mode. The communication may include an indication of whether a limit switch is actuated, an indication of battery life at the sending device, and an identifier that identifies the sending device. The sending devices may be electronic sensing devices, such as limit switches. The communication may be received by a receiver wirelessly over a network.

The status indicators are stored in a memory device (404). The status indicators may be stored in association with an identifier (e.g., the received identifier) that identifies the sending device, so that the indicator may be later referenced by the identifier. The first device receives a first input comprising a first actuation duration via a button while operating in the first mode (406). The button may be a two-position, tactile button. The actuation duration may correspond to a length of time that the button is actuated to provide the first input.

If the first actuation duration is not longer than a debounce duration (408), or if the first actuation duration is longer than the debounce duration (408) but is not longer than a first duration (410) the device returns to the step of receiving a first input via the button (406). If the first actuation duration is longer than the debounce duration (408), longer than the first duration (410), and longer than a second duration (412), the first device is configured to operate in a third mode (414). If the first actuation duration is longer than the debounce duration (408), longer than the first duration (410), but shorter than the second duration (412), the first device is configured to operate in a second mode (416). The first duration may be substantially longer than the debounce duration. The second duration may be substantially longer than the first duration. For example, the debounce duration may be about 100 milliseconds, the first duration may be about 1 second, and the second duration may be about 4 seconds. The second mode may be a troubleshooting mode. The third mode may be a pairing mode.

A visual indication of a stored status indicator is provided on an output device (418). The output device may include two or more two-position output components. Examples of two-position output components include LEDs or buzzers. One example output device includes three LEDs and one buzzer. In some examples the visual indication can include an audible indication, such as a sounding of a buzzer. A toggle input is received via the button (420). If a number of toggle inputs received does not equal the number of stored status indicators (422), the device returns to the step of providing a visual indication of a stored status indicator on the output device (418). If the number of toggle inputs received equals the number of stored status indicators (422), a second input is received via the button (424). The device is configured to operate in the first mode (426). The first mode may be a normal operating mode.

In some examples, prior to receiving any of the communications, the first device (e.g., the device discussed above) may be communicably coupled with each device of the plurality of devices, including receiving, while operating in the first mode, a third input via the button and comprising a third actuation duration that is longer than the second duration. The first device is configured to operate in the third mode responsive to receiving the third input. While operating in the third mode, an initial communication may be received from each device of the plurality of devices, where each initial communication includes a request to be monitored by the first device. An acceptance communication may be transmitted from the first device to each respective device of the plurality of devices responsive to receipt of the respective initial communication. Each acceptance communication may include an identifier that uniquely identifies the respective device among the plurality of devices. In various examples, the initial communications may be transmitted by the respective devices responsive to receiving an input at the respective device via a button of the respective device.

While the first device is operating in the first mode, the first device may provide a visual indication of a composite status on the output device, where the composite status may be a collective representation of each of the stored status indicators. The stored status indicators of each respective device may be retrieved, and a composite status indicator may be determined based at least in part on the stored status indicators.

The techniques described in this disclosure may be implemented within one or more of a general purpose microcontroller, microprocessor, digital signal processor (DSP), application specific integrated circuit (ASIC), field programmable gate array (FPGA), programmable logic device (PLD), or other equivalent logic devices. Accordingly, the terms “processor” or “controller,” as used herein, may refer to any one or more of the foregoing structures or any other structure suitable for example of the techniques described herein.

The various components illustrated herein may be realized by any suitable combination of hardware, software, or firmware. In the figures, various components are depicted as separate units or modules. However, all or several of the various components described with reference to these figures may be integrated into combined units or modules within common hardware, firmware, and/or software. Accordingly, the representation of features as components, units or modules is intended to highlight particular functional features for ease of illustration, and does not necessarily require realization of such features by separate hardware, firmware, or software components. In some cases, various units may be implemented as programmable processes performed by one or more processors.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset.

If implemented in software, the techniques may be realized at least in part by a computer-readable data storage medium comprising code with instructions that, when executed by one or more processors, performs one or more of the methods described above. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

Various embodiments of the invention have been described. These and other embodiments are within the scope of the following claims.

1. A method comprising:
receiving, at a first electronic device, a communication from each of a plurality of electronic sensing devices, wherein each of the received communications includes a status indicator representative of a status of the respective electronic sensing device, and wherein the first electronic device is configured to operate in a first mode of a plurality of operating modes while the communications are received;
storing, in a memory device accessible by the first electronic device, the status indicators included, respectively, in the received communications;
receiving, at the first electronic device while the first electronic device is operating in the first mode and via a button of the first electronic device, a first input comprising a first actuation duration that corresponds to a length of time that the button is actuated to provide the first input, the first actuation duration being:
longer than a debounce duration for the button;
longer than a first duration, the first duration being substantially longer than the debounce duration; and
shorter than a second duration, the second duration being substantially longer than the first duration;
wherein, responsive to receiving the first input comprising the first actuation duration, the first electronic device is configured to operate in a second mode of the plurality of operating modes, and wherein an input received via the button while the first electronic device is operating in the first mode and comprising an actuation duration longer than the second duration causes the first electronic device to be configured to operate in a third mode of the plurality of operating modes, the third mode being different than the first mode or the second mode;
providing, for each of the stored status indicators while the first electronic device is operating in the second mode, a visual indication of the respective status indicator on an output device of the first electronic device, wherein transitions between the provided visual indications of the status indicators occur in response to toggle inputs received via the button; and
receiving, after providing the visual indications of the stored status indicators, a second input via the button, wherein the first electronic device is configured to operate in the first mode responsive to receiving the second input.

2. The method of claim 1, wherein prior to receiving the communications, the first electronic device is communicably coupled with each of the plurality of electronic sensing devices, the method further comprising:
receiving, at the first electronic device while the first electronic device is operating in the first mode and via the button, a third input comprising a third actuation duration that is longer than the second duration, wherein the first electronic device is configured to operate in the third mode responsive to receiving the third input comprising the third actuation duration;
receiving, at the first electronic device while the first electronic device is operating in the third mode, an initial communication from each of the electronic sensing devices, each initial communication including a request to be monitored by the first electronic device; and
transmitting, from the first electronic device to each respective device of the plurality of electronic sensing devices responsive to the receipt of the respective initial communication, an acceptance communication that comprises an identifier that uniquely identifies the respective device among the plurality of electronic sensing devices.

3. The method of claim 2, wherein the initial communications are respectively transmitted by the respective device of the plurality of electronic sensing devices responsive to receiving an input at the respective device.

4. The method of claim 1, wherein prior to receiving the communications, the first electronic device is communicably coupled with each of the plurality of electronic sensing devices, the method further comprising:
receiving, at the first electronic device while the first electronic device is operating in the first mode and via the button, a third input comprising a third actuation duration that is longer than the debounce duration and shorter than the first duration, wherein the first electronic device is configured to operate in a fourth mode responsive to receiving the third input comprising the third actuation duration;
receiving, at the first electronic device while the first electronic device is operating in the fourth mode, an initial communication from each of the electronic sensing devices, each initial communication including a request to be monitored by the first electronic device; and
transmitting, from the first electronic device to each respective device of the plurality of electronic sensing devices responsive to the receipt of the respective initial communication, an acceptance communication that comprises an identifier that uniquely identifies the respective device among the plurality of electronic sensing devices.

5. The method of claim 1, wherein while the first electronic device is operating in the first mode the first electronic device provides a visual indication of a composite status on the output device, the composite status being a collective representation of each of the stored status indicators.

6. The method of claim 1, wherein the button comprises a two-position, tactile button.

7. The method of claim 1, wherein each device in the plurality of electronic sensing devices comprises a limit switch.

8. An electronic monitoring device comprising:
a receiver;
a memory device;
a button;
an output device; and
a control module, configured to:
receive, via the receiver, a communication from each of a plurality of electronic sensing devices, wherein each of the received communications includes a status indicator representative of a status of the respective electronic sensing device, and wherein the electronic monitoring device is configured to operate in a first mode of a plurality of operating modes while the communications are received;
store, in the memory device, the status indicators included, respectively, in the received communications;
receive, while the electronic monitoring device is operating in the first mode and via the button, a first input comprising a first actuation duration that corresponds to a length of time that the button is actuated to provide the first input, the first actuation duration being:
longer than a debounce duration for the button;
longer than a first duration, the first duration being substantially longer than the debounce duration; and
shorter than a second duration, the second duration being substantially longer than the first duration;
wherein, responsive to receiving the first input comprising the first actuation duration, the control module configures the electronic monitoring device to operate in a second mode of the plurality of operating modes, and wherein an input received via the button while the electronic monitoring device is operating in the first mode and comprising an actuation duration longer than the second duration causes the control module to configure the electronic monitoring device to operate in a third mode of the plurality of operating modes, the third mode being different than the first mode or the second mode;
provide, for each of the stored status indicators while the electronic monitoring device is operating in the second mode, a visual indication of the respective status indicator on the output device, wherein transitions between the provided visual indications of the status indicators occur in response to toggle inputs received via the button; and
receive, after providing the visual indications of the stored status indicators, a second input via the button and configure the electronic monitoring device to operate in the first mode, responsive to receiving the second input.

9. The electronic monitoring device of claim 8, wherein prior to receiving the communications, the electronic monitoring device is communicably coupled with each of the plurality of electronic sensing devices, comprising:
receiving, at the first electronic device while the first electronic device is operating in the first mode and via the button, a third input comprising a third actuation duration that is longer than the second duration, wherein the first electronic device is configured to operate in the third mode responsive to receiving the third input comprising the third actuation duration;
receiving, at the first electronic device while the first electronic device is operating in the third mode, an initial communication from each of the electronic sensing devices, each initial communication including a request to be monitored by the first electronic device; and
transmitting, from the first electronic device to each respective device of the plurality of electronic sensing devices responsive to the receipt of the respective initial communication, an acceptance communication that comprises an identifier that uniquely identifies the respective device among the plurality of electronic sensing devices.

10. The electronic monitoring device of claim 9, wherein the initial communications are respectively transmitted by the respective device of the plurality of electronic sensing devices responsive to receiving an input at the respective device.

11. The electronic monitoring device of claim 8, wherein prior to receiving the communications, the first electronic device is communicably coupled with each of the plurality of electronic sensing devices, comprising:
receiving, at the first electronic device while the first electronic device is operating in the first mode and via the button, a third input comprising a third actuation duration that is longer than the debounce duration and shorter than the first duration, wherein the first electronic device is configured to operate in a fourth mode responsive to receiving the third input comprising the third actuation duration;
receiving, at the first electronic device while the first electronic device is operating in the fourth mode, an initial communication from each of the electronic sensing devices, each initial communication including a request to be monitored by the first electronic device; and
transmitting, from the first electronic device to each respective device of the plurality of electronic sensing devices responsive to the receipt of the respective initial communication, an acceptance communication that comprises an identifier that uniquely identifies the respective device among the plurality of electronic sensing devices.

12. The electronic monitoring device of claim 8, wherein while the electronic monitoring device is operating in the first mode the electronic monitoring device provides a visual indication of a composite status on the output device, the composite status being a collective representation of each of the stored status indicators.

13. The electronic monitoring device of claim 8, wherein the button comprises a two-position, tactile button.

14. The electronic monitoring device of claim 8, wherein each device in the plurality of electronic sensing devices comprises a limit switch.

15. A computer-readable medium comprising instructions for causing a programmable processor to:
receive, at a first electronic device, a communication from each of a plurality of electronic sensing devices, wherein each of the received communications includes a status indicator representative of a status of the respective electronic sensing device, and wherein the first electronic device is configured to operate in a first mode of a plurality of operating modes while the communications are received;
store, in a memory device accessible by the first electronic device, the status indicators included, respectively, in the received communications;
receive, at the first electronic device while the first electronic device is operating in the first mode and via a button of the first electronic device, a first input comprising a first actuation duration that corresponds to a length of time that the button is actuated to provide the first input, the first actuation duration being:
longer than a debounce duration for the button;
longer than a first duration, the first duration being substantially longer than the debounce duration; and
shorter than a second duration, the second duration being substantially longer than the first duration;
wherein, responsive to receiving the first input comprising the first actuation duration, the first electronic device is configured to operate in a second mode of the plurality of operating modes, and wherein an input received via the button while the first electronic device is operating in the first mode and comprising an actuation duration longer than the second duration causes the first electronic device to be configured to operate in a third mode of the plurality of operating modes, the third mode being different than the first mode or the second mode;
provide, for each of the stored status indicators while the first electronic device is operating in the second mode, a visual indication of the respective status indicator on an output device of the first electronic device, wherein transitions between the provided visual indications of the status indicators occur in response to toggle inputs received via the button; and
receive, after providing the visual indications of the stored status indicators, a second input via the button, wherein the first electronic device is configured to operate in the first mode responsive to receiving the second input.

16. The computer-readable medium of claim 15, wherein prior to receiving the communications, the first electronic device is communicably coupled with each of the plurality of electronic sensing devices, comprising:
receiving, at the first electronic device while the first electronic device is operating in the first mode and via the button, a third input comprising a third actuation duration that is longer than the second duration, wherein the first electronic device is configured to operate in the third mode responsive to receiving the third input comprising the third actuation duration;
receiving, at the first electronic device while the first electronic device is operating in the third mode, an initial communication from each of the electronic sensing devices, each initial communication including a request to be monitored by the first electronic device; and
transmitting, from the first electronic device to each respective device of the plurality of electronic sensing devices responsive to the receipt of the respective initial communication, an acceptance communication that comprises an identifier that uniquely identifies the respective device among the plurality of electronic sensing devices.

17. The computer-readable medium of claim 16, wherein the initial communications are respectively transmitted by the respective device of the plurality of electronic sensing devices responsive to receiving an input at the respective device.

18. The computer-readable medium of claim 15, wherein prior to receiving the communications, the first electronic device is communicably coupled with each of the plurality of electronic sensing devices, comprising:
receiving, at the first electronic device while the first electronic device is operating in the first mode and via the button, a third input comprising a third actuation duration that is longer than the debounce duration and shorter than the first duration, wherein the first electronic device is configured to operate in a fourth mode responsive to receiving the third input comprising the third actuation duration;
receiving, at the first electronic device while the first electronic device is operating in the fourth mode, an initial communication from each of the electronic sensing devices, each initial communication including a request to be monitored by the first electronic device; and
transmitting, from the first electronic device to each respective device of the plurality of electronic sensing devices responsive to the receipt of the respective initial communication, an acceptance communication that comprises an identifier that uniquely identifies the respective device among the plurality of electronic sensing devices.

19. The computer-readable medium of claim 15, wherein while the first electronic device is operating in the first mode the first electronic device provides a visual indication of a composite status on the output device, the composite status being a collective representation of each of the stored status indicators.

20. The computer-readable medium of claim 15, wherein the button comprises a two-position, tactile button.
